(19) United States
(12) Patent Application Publication
(10) Pub. No.: US 2010/0085149 A1
(43) Pub. Date: Apr. 8, 2010

(54) Systems and Methods for Mounting a Security Device

(75) Inventors: Roc Lastinger, Cave Creek, AZ (US); John Spenik, Phoenix, AZ (US); Brian Woodbury, Gilbert, AZ (US)

Correspondence Address: LETHAM LAW FIRM, LLC, 914 N. TUCANA LANE, GILBERT, AZ, 85234, US

(73) Assignee: Roc2Loc Inc., San Francisco, CA (US)

(21) Appl. No.: 12/627,027

(22) Filed: Nov. 30, 2009

Related U.S. Application Data
(63) Continuation-in-part of application No. 11/955,665, filed on Dec. 13, 2007, now Pat. No. 7,667,600.
(60) Provisional application No. 60/874,996, filed on Dec. 16, 2006.
(60) Provisional application No. 60/897,785, filed on Jan. 26, 2007.

(51) Int. Cl. H04L 9/32

(52) U.S. Cl. 340/5.74

(57) ABSTRACT

A mount according to the various aspects of the present invention for coupling to a provided object, releasably coupling a provided security device, and providing an information. The mount includes a body, a first coupler, a second coupler, a conductor, and a data carrier. The first coupler for coupling the body to the object. The second coupler for releasably coupling the body to the security device. The conductor for electrically coupling to the security device. The data carrier is positioned in the body and electrically couples to the conductor to provide the information via the conductor. The security device receives the information only while coupled to the second coupler. The data carrier remains in the body while the security device is decoupled from second coupler. The information comprises a unique identifier.

### CROSS-REFERENCE TO RELATED APPLICATIONS

This application is a continuation-in-part under 35 U.S.C. §120 of U.S. application Ser. No. 11/955,665 filed Dec. 13, 2007 which claims the benefit under 35 U.S.C. §119(e) of U.S. Provisional Application No. 60/874,996 filed Dec. 16, 2006 and U.S. Provisional Application No. 60/897,785 filed Jan. 26, 2007. All above applications are herein incorporated by reference.

### FIELD OF THE INVENTION

The present invention relate to mounting security devices and identifying a mount.

### BACKGROUND OF THE INVENTION

A security device may mount to an object to monitor the object or to monitor an area proximate to the object. Security providers may benefit from a security device that quickly mounts to an object to provide security monitoring during a time of need and releases from the object in a time of no need. A security device may benefit from a mount that is mechanically coupled to an object that releasably accepts the security device for mounting. A security device may further benefit form a mount that identifies itself to the security device.

### SUMMARY OF THE INVENTION

A mount according to the various aspects of the present invention for coupling to a provided object, releasably coupling a provided security device, and providing an information. The mount includes a body, a first coupler, a second coupler, a conductor, and a data carrier. The first coupler for coupling the body to the object. The second coupler for releasably coupling the body to the security device. The conductor for electrically coupling to the security device. The data carrier is positioned in the body and electrically couples to the conductor to provide the information via the conductor. The security device receives the information only while coupled to the second coupler. The data carrier remains in the body while the security device is decoupled from second coupler. The information comprises a unique identifier.

### BRIEF DESCRIPTION OF THE DRAWING

Embodiments of the present invention will now be further described with reference to the drawing, wherein like designations denote like elements, and:

FIG. 1 is a functional block diagram of a mount according to various aspects of the present invention, an object and a security device proximate to the mount;

FIG. 2 is a functional block diagram of a mount according to various aspects of the present invention, an object and a security device on a side of the object opposite the mount;

FIG. 3 is a functional block diagram of a mount according to various aspects of the present invention, an object, a first security device proximate to the mount, and a second security device on a side of the object opposite the mount;

FIG. 4 is a functional block diagram of a mount according to various aspects of the present invention; and

FIGS. 5 and 6 are a plan view of an implementation of the mount of FIG. 3.

### DETAILED DESCRIPTION OF THE PREFERRED EMBODIMENTS

Security devices are used in many situations to detect (e.g., monitor, sense, measure) and provide notices (e.g., alarm, report, electronic message) of events (e.g., disturbance, change, access, disabling, enabling, lack of change). Some security devices are mounted (e.g., affixed, secured, attached) to an object in such a manner that removing the security device requires a high effort (e.g., time, planning, work, special tools, specialized knowledge). A coupling (e.g., mounting) that requires a high effort to decouple is referred to herein as a long-term coupling. A security device may benefit from a long-term mounting when the assets being secured are not mobile or the value of assets stored in an area is continuously greater than a threshold (e.g., all assets not removed from the area).

In a situation where assets are mobile or assets are not continuously present in an area, a security device may be used only a portion of the time (e.g., when assets are present). A security device may be relatively expensive, thus an owner of a security device (e.g., individual, corporation, lessor) may desire continuous use of the security device to justify or recoup the cost of the device. A user (e.g., individual, corporation, lessee) of a security device may wish to bear the expense of a security device only in a time of need. Thus, providers of security may benefit from a mount having a long-term coupling to an object or in an area that provides a temporary (e.g., quick release, less work, less time, conventional tools, layman knowledge) coupling to a security device and confirmation that a security device is coupled to the mount. In a time of need, the security device releasably couples to the mount to provide security services. When the need for security ends, the security device is decoupled form the mount and deployed to another situation of need. The mount remains coupled to the object or in the area for use when another need arises.

For example, a shipping container contains assets while in transit. The value (e.g., market, replacement cost, sentimental) of the assets may be such that the owner of the assets desires to monitor the assets while in transit. The shipper (e.g., container owner) desires the flexibility of not dedicating specific containers for high value goods and resists installing security device on containers. However, a shipper may be inclined to install an inexpensive mount on all containers thereby maintaining flexibility of container deployment while enabling security devices to be coupled only to containers of interest. A mount on every container would enable the shipper to provide security monitoring for a fee or attract business from entities that provide their own security devices.

A mount that identifies itself to a security device enables the security device to detect a time of coupling and a time of decoupling. A mount that provides a unique identifier (e.g., serial number, encrypted) enables a security device to detect when it is coupled to a specific mount. A unique one-to-one correspondence between mounts and objects to which the mounts are coupled provides information that may be used to determine whether a security device is coupled to a specific object.

A mount according to various aspects of the present invention mechanically couples to an object (e.g., wall, door, cargo container, trailer, box car, safe, vehicle, luggage). A mount provides a long-term mechanical coupling to the object. A mount provides a temporary coupling to at least one security device. A mount electrically couples to a security device. A mount identifies itself to a security device. A mount may include a unique identifier (e.g., serial number). A mount may provide its unique identifier to a security device. A known relationship may be established between a mount and an object thereby enabling a security device to determine whether it is coupled via the mount to a specific object or positioned in a specific area.

A mount may detect information (e.g., data) from a security device. Information from a security device may include a unique identifier, a model number, a manufacturer, an owner, a user, a shipper, a security monitoring company identifier, a configuration of the security device, and a status (e.g., functional, recharging, reporting, power level). A mount may receive, store, and report information from a security device.

A mount that receives and stores information may provide a log of security devices coupled to the mount. A one-to-one correspondence between a mount and an object enables a mount to provide a log of security devices coupled to the object or in an area.

A mount may receive information about an object. Information about the object may include a unique identifier (e.g., serial number, license number, vehicle identification number), type, model, weight, owner, lessee, lessor, location if stationary (e.g., address, GPS coordinate), structural condition, history, size, manufacturer, date of manufacture, and service record. A mount may receive, store, and report information about an object. Information about the object may be used by the mount to form a log or a security device to verify coupling to a specific object.

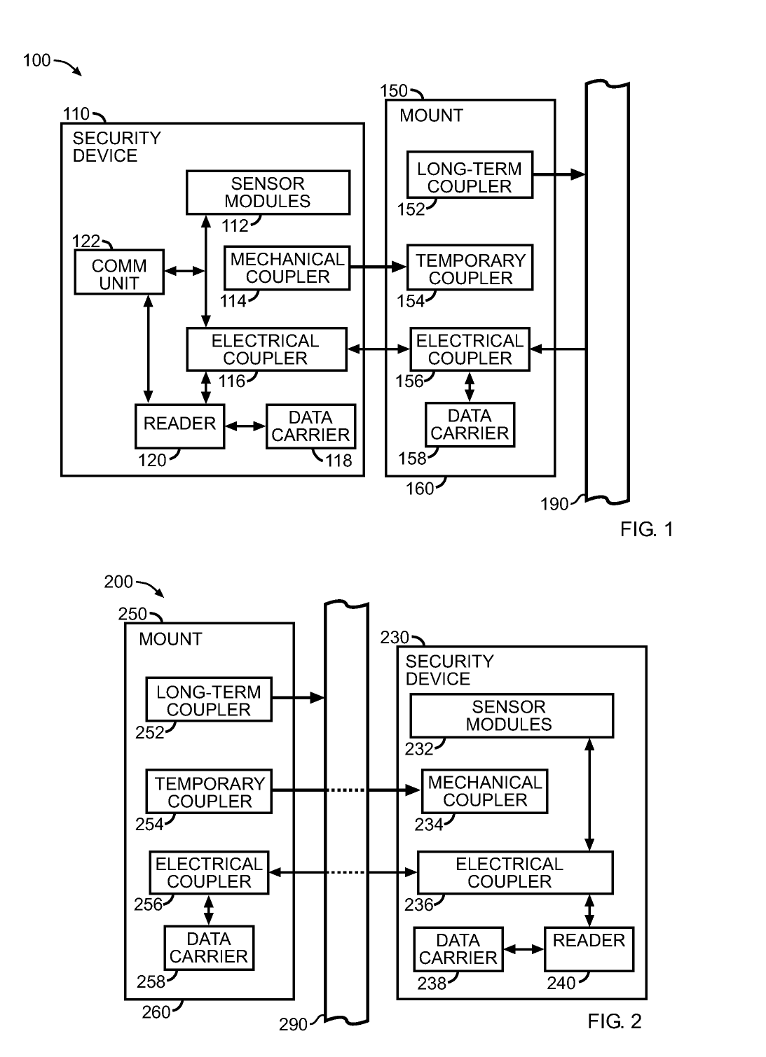

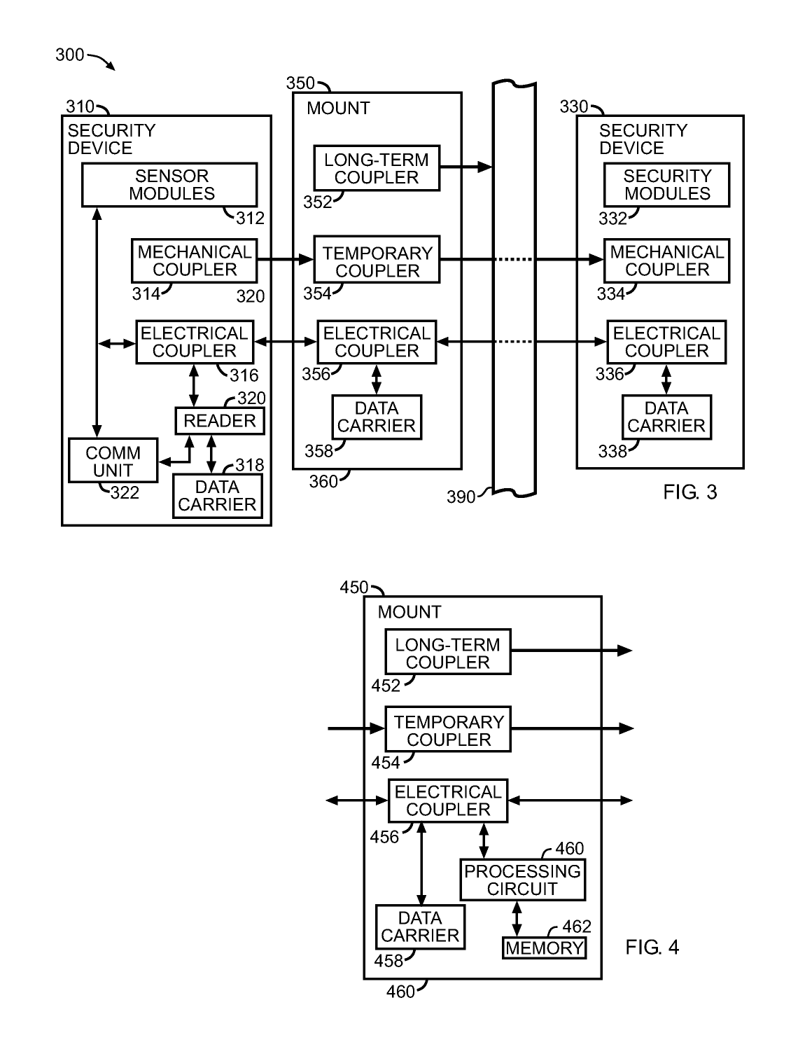

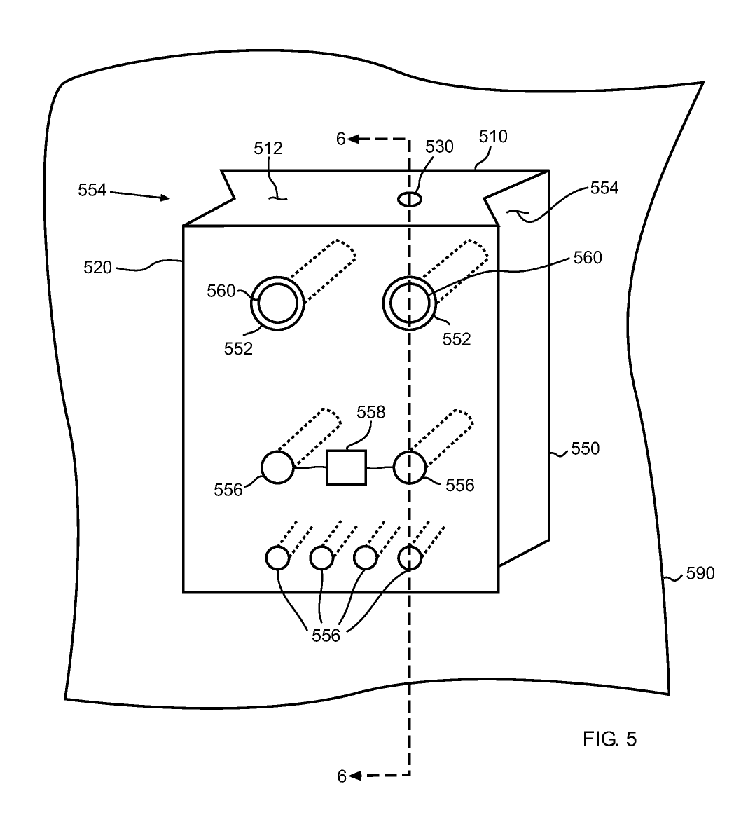

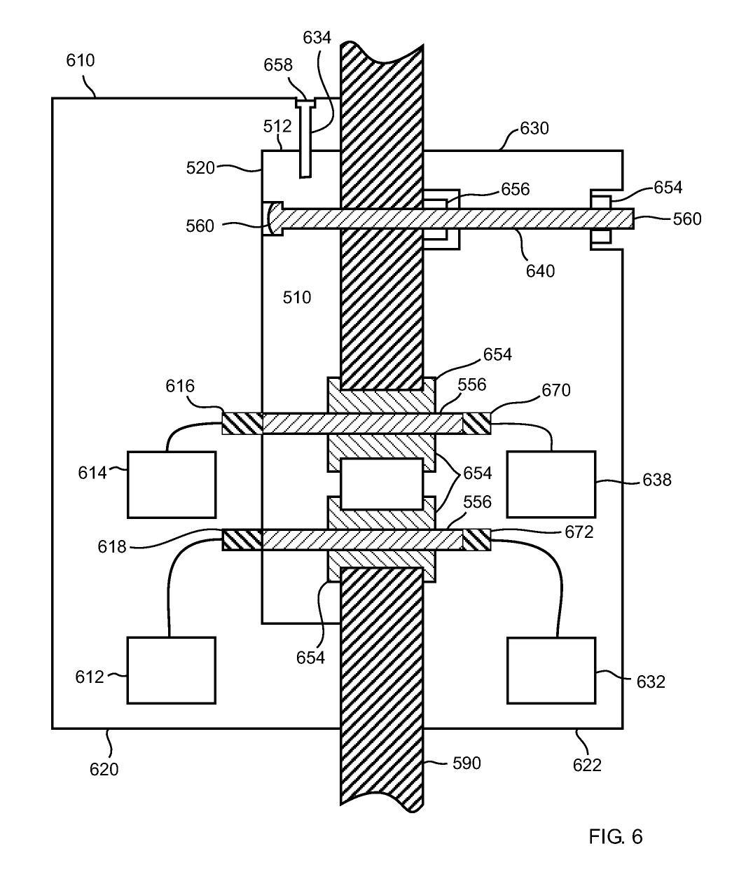

For example, mounts 150, 250, 350, and 450 of FIGS. 1-6, according to various aspects of the present invention, couple to an object for long-term coupling; temporarily couple to one or more security devices of security systems 100, 200, and 300; electrically couple to one or more security devices; provide a unique identifier; detect, receive, store, and report information from a security device; and receive, store, and report information about an object.

A mount includes body 160, 260, 360, and 460; long-term coupler 152, 252, 352, and 452; temporary coupler 154, 254, 354, and 454; electrical coupler 156, 256, 356, and 456; and data carrier 158, 258, 358, and 458. A mount may further include processing circuit 460 and memory 462.

A body provides structure for coupling to an object and supporting (e.g., housing, arranging, positioning) components (e.g., couplers, data carrier, processing circuit, memory, conductors) of the mount. A body may be formed of any material (e.g., plastic, metal, composite, nano) or combination of materials. Structure of a body may partially or fully form a coupler. A body may cooperate with structure of an object to couple the mount to the object. A body may contact an object to accomplish coupling. A portion of a body may partially or fully traverse (e.g., pierce, pass through) a portion of an object to accomplish coupling. A shape of a body may cooperate with a shape of an object or a security device to accomplish coupling.

In an embodiment, body 160 (260, 360, 460) is formed of plastic. Data carrier 158 (258, 358, 458) is positioned on or in body 160. Body 160 supports two or more conductors for coupling data carrier 158 to electrical coupler 156. Structure of body 160 partially or fully forms long-term coupler 152 (252, 352, 452) and temporary coupler 154 (254, 354, 454). Body 160 may included any conventional structure (e.g., hole, projection, surface, threads, clip, cantilever, groove, screw, bolt, clamp) for mechanically coupling. Body 160 includes and positions two or more conductors that form electrical coupler 156 (256, 356, 456). Body 160 may include any conventional structure (e.g., contact, electrode, key connector, plug) for electrically coupling.

Discussion about a component that has an indicator in the drawing, equally applies to the corresponding component in each figure of the mount without repetition of the different indicator number for the component unless otherwise indicated. For example, a description of body 160 equally applies to body 260, 360, and 460 without expressly listing each indicator as provided above. Any differences between body 160, 260, 360, and 460 or any other components that provide a similar function or bare the same name are expressly stated.

A long-term coupler mechanically couples a mount to an object. A long-term coupler resists easy (e.g., without tools, quick, permission to access) removal of the mount from the object. A long-term coupler may cooperate with an object to provide long-term coupling. A long-term coupler may cooperate with any conventional mechanical coupler (e.g., screw, bolt, adhesive, clip, clamp) to couple the mount to the object.

In an implementation, long-term coupler 152 includes a bore in body 160. The bore, or at least a portion thereof, permits passage of the threads and shank of a bolt, but not the head or nut threaded on the threads. The bolt passes through the bore and into a portion (e.g., threaded bore) or through object 190. The head of the bolt or nut on the threads mechanically couples body 160 of mount 150 to object 190. In an implementation, structure of body 160 forms long-term coupler 152 as a surface for adhering (e.g., glue, solder, welding) mount 150 to object 190.

The materials that form portions of body 160 may differ to provide coupling. For example, a portion of body 160 may be formed of a metal to provide a surface for long-term coupler 152 to be welded to object 190. Other portions of body 160 may be formed of plastic or another insulator to separate the conductors of electrical coupler 156 from each other and from any metal portion of long-term coupler 152.

A temporary coupler mechanically couples a security device to at least a portion of a body of a mount. A temporary coupler provides easy removal of the security device from the mount. A temporary coupler may cooperate with a security device to provide temporary coupling. A temporary coupler may cooperate with any conventional mechanical coupler (e.g., screw, bolt, adhesive, clip, clamp) to couple the security device to the mount.

A temporary coupler releasably couples a security device to a mount. A temporary coupler may couple for any duration of time. A temporary coupler may require the use of tools, even specialized tools, to make, break, or secure a coupling. A temporary coupler may include a coupler that resists a force of removal or a force that results from use (e.g., gravity, bounce, scraping) that may result in removal.

As set forth above, the body of a mount may provide structure for temporarily coupling the security device to the mount. The mechanical coupler the security device may provide structure for cooperating with the temporary coupler. In an implementation, temporary coupler 154 includes the male portion (e.g., protrusion having pins that extend from the male portion) of a bayonet mount while mechanical coupler 114 of security device 110 includes the female portion. The bayonet mount as implemented by temporary coupler 154 and mechanical coupler 114 temporarily couples security device 110 to mount 150.

A temporary coupler may couple to a security device proximate to a mount or through a portion of an object. In an implementation, temporary coupler 154 couples to mechanical coupler 114 of security device 110 while security device 110 is positioned proximate to mount 150. Temporary coupler 254 couples through a portion of object 290 to mechanical coupler 234 of security device 230. Temporary coupler 354 couples to mechanical coupler 314 of security device 310 positioned proximate to mount 350 and to mechanical coupler 334 through object 390.

An electrical coupler of a mount electrically couples to at least one security device. An electrical coupler includes conductors for conducting electrical energy (e.g., voltage, current, voltage waveform, current waveform, voltage pulse, current pulse). An electrical coupler includes any conventional electrical coupler (e.g., terminal block, plug, socket, modular plug, modular jack, RJ45, D-subminiature, USB plug, USB socket, NEMA connector, terminal, electrode, BNC, wire). A security device may provide power to a mount via an electrical coupler or visa versa. A reader may receive information (e.g., data) from a data carrier via an electrical coupler. An electrical coupler may further mechanically couple. Any mechanical portion of an electrical coupler releasably couples to enhance coupling provided by a temporary coupler. As set forth above with respect to a temporary coupler, an electrical coupler of a mount may electrically couple to a security device positioned proximate to the mount or through an object to a security device.

In an implementation, electrical coupler 156 of mount 150 electrically couples to electrical coupler 116 of security device 110 positioned proximate to mount 150. In an implementation, electrical coupler 256 of mount 250 traverses object 290 to electrically couple to electrical coupler 236 of security device 230. In an implementation, electrical coupler 356 of mount 350 electrically couples to electrical coupler 316 of proximate security device 310 and to electrical coupler 336 through object 390.

A processing circuit includes any circuit that receives, provides, stores, and processes information. A processing circuit may execute a stored program. A processing circuit includes any conventional microprocessor, signal processor, state machine, or programmable logic device. A processing circuit may receive information from a security device and provide a notice about the information from a security device. A processing circuit may provide information about the object to which the mount is coupled. A processing circuit may perform a function of a reader. A processing circuit may receive information from one or more data carriers. A processing circuit may provide information to a security device.

A security device may communicate (e.g., transmit, receive) information. A security device may receive information for communication from any source including a processing circuit, a reader, and a data carrier. A security device may receive information for communication via an electrical coupler. A security device may include a communication unit (e.g., 122, 322) that performs communication. A communication unit may communicate using any conventional protocol and over any conventional medium (e.g., wired, wireless, optical). A communication unit may transmit an identification number form a mount or another security device to provide evidence of coupling to the mount or security device. A security device may include a communication unit having a communication protocol adapted for communicating using communication networks of a specific locale (e.g., country, region).

A memory receives, stores, and provides information. A memory includes any conventional memory (e.g., RAM, ROM, Flash, EPROM). A memory may receive information from a processing circuit for storage. A memory may provide information to a processing circuit. A memory may store a program executed by a processing circuit. A memory may store information about an object to which the mount is coupled.

A data carrier stores and provides information. A data carrier may be of the type of data carrier (e.g., tag) described in U.S. application Ser. No. 12/027,235 filed Feb. 6, 2008 entitled “Systems and Methods for Managing Objects,” herein incorporated by reference; or described in U.S. application Ser. No. 12/348,060 filed Jan. 2, 2009 entitled “Systems and Methods for Tracking Chemicals, Dispensing Chemicals, and Preparing Chemical Compositions,” herein incorporated by reference.

A data carrier mounts. A data carrier electrically couples to at least one conductor of an electrical coupler. A data carrier may store a unique identifier (e.g., serial number). A unique identifier of a data carrier of a mount may further identify the object to which the mount is coupled. A data carrier of a mount may provide information to a security device. A security device may provide a notice about the information received from a data carrier of the mount. A notice includes a message that includes the identifier.

A security device may receive information from a data carrier while the security device is coupled to the mount, thus receipt of an identifier from a mount may indicate that the security device is coupled to the mount. An inability to receive an identifier or receipt of an identifier from a different mount may indicate that the security device is not coupled to the mount or is coupled to an undesirable mount.

A reader receives information from one or more data carriers via at least one conductor. In an implementation, two conductors coupled a reader to one or more data carriers. One conductor provides a reference voltage (e.g., ground, common) while the other conductor receives information from one or more data carriers as described in the applications herein incorporated by reference. A reader may be of the type described in any of the applications herein incorporated by reference.

Coupling between security devices to receive information from a data carrier may be provided by an optical or mechanical device. In an implementation, a security device includes an optical receiver that receives optical signals from an optical transmitter of a mount. The optical signals include information from the data carrier of the mount.

A security device detects and provides notices. A security device may be of the type of security devices (e.g., security device, communication device, site controller, yard system, trailer system, mobile transceiver, stationary transceiver) described in U.S. application Ser. No. 11/955,665 filed Dec. 13, 2007 entitled “Methods and Apparatus for Security Device Removal Detection,” incorporated by reference above; U.S. provisional application No. 61/041,526 filed Apr. 1, 2008 entitled “Methods and Apparatus for Security Device Portal Sensing,” herein incorporated by reference; U.S. provisional application No. 61/084,966 filed Jul. 30, 2008 entitled “Methods and Apparatus for a Personality Device and Methods and Apparatus for Communicating and Docking with a Secondary Device,” herein incorporated by reference; U.S. provisional application No. 61/084,971 filed Jul. 30, 2008 entitled “Methods and Apparatus for a Site Controller,” herein incorporated by reference; U.S. provisional application No. 61/091,255 filed Aug. 22, 2008 entitled “Methods and Apparatus for Monitoring, Managing, and Pairing Engines, Containers, and Cargo,” herein incorporated by reference; or U.S. provisional application No. 61/109,138 filed Oct. 28, 2008 entitled “Systems and Methods for Detecting a Position of an Object,” herein incorporated by reference.

In an implementation, mount 510 mounts to object 590 and provides electrical conductors through a portion of object 590. Long-term coupler of mount 510 includes bores 552 through mount 510, bolts 560, and nut 656. Bolts 560 insert through bores 552 and through a bore in object 590. A head of bolt 560 engages a body 520 of mount 510. Nut 656 threadedly couples to bolt 560 on a side of object 590 opposite mount 510. Bolt 560 and nut 656 cooperate to mechanically couple mount 510 to object 590. Bolt 560 may be an integral portion of body 520 of mount 510.

Temporary coupler of mount 510 for mounting proximate to mount 510 includes grooves 554, bore 530 and bolt 652. Security device 610 mounts proximate to mount 510 and includes projections (not shown) that slidedly engages grooves 554 (e.g., tongue and groove, dovetail). While the projections of security device 610 engage grooves 554, movement of security device 610 is restricted along grooves 554. Security device 610 slides along grooves 554 until a portion of body 620 of security device 610 contacts side 512 of body 520 of mount 510. Bolt 658 passes through bore 634 in the body of security device 610 and threadedly engages bore 530 of security device 510. While projections of security device 610 engage grooves 554 and bolt 658 engages threads of bore 530, security device 610 is temporarily coupled to mount 510.

Temporary coupler of mount 510 for mounting through object 590 includes bolt 560 and nut 654. The end portion of bolt 560 that is exposed on a side of object 590 opposite mount 510 fits through bore 640 in body 622 of security device 630. Nut 654 threadedly couples to threads of bolt 560 to mechanically mount security device 630 to mount 510.

Electrical coupler of mount 510 includes conductors 556 and insulators 654. Insulators 654 may be omitted when the material of object 590 insulates conductors 556 from each other. Conductors 556 may comprise bolts that conduct electricity and further mechanically couple mount 510 to object 590. Conductors 556 are exposed on the proximate side of mount 510 and the opposite side of object 590 for contact with contacts 616 and 618 of security device 610 and contacts 670 and 672 of security device 630. Contacts 616, 618, 670 and 672 may be biased to press against conductors 556 to establish an electrical connection.

Two conductors 556 electrically couple to data carrier 558 of mount 510, data carrier 638 of security device 630, and reader 614 of security device 610. Reader 614 reads information from data carriers 558 and 638 in any manner described in the applications incorporated by reference herein.

A security module of a security device includes the modules that detect and provide notices. A security module may include a power supply that provides power to any portion of a security device including a reader. A security module may further provide power to a mount via a conductor of an electrical coupler. Conductors 556 further electrically couple security module 612 of security device 610 to security module 632 of security device 630. Information may be transferred between security modules 612 and 632 in any conventional manner (e.g., data bus). Information may include information from data carriers.

A long-term coupler, a temporary coupler, and an electrical coupler may share structure to provide coupling. Magnetic mount of the type in U.S. application Ser. No. 11/955,665 (“'665”), described above, may provide both long-term and temporary coupling. Fastener 2206 of FIG. 22 of the '665 application mechanically couples to portal cover (e.g., door) 2210. Fasteners 2206 are coupled to portal cover 2210 in such a manner as to provide a long-term coupling. Fasteners 2206 conduct electricity and magnetically couple to magnets. Magnets 2214 of security device 2202 magnetically and electrically couple to fasteners 2206. The force of magnetic coupling provides a temporary coupling. The electrical coupling between magnets 2214, fastener 2206 and components of security device 100 (e.g., body 2202) performs the function of an electrical coupler. Data carrier 158, 258, 358, 458, or 558 of the present invention is not shown in FIG. 22 of the '665 application; however, a data carrier may couple to fasteners 2206 in any manner that provides an electrical coupling. Furthermore, a data carrier may be positioned at any location with respect to fasteners 2206 including in a cavity of a fastener 2206 or embedded in insulation 2208.

The foregoing description discusses preferred embodiments of the present invention, which may be changed or modified without departing from the scope of the present invention as defined in the claims. The examples listed in parentheses may be alternative or combined in any manner. The invention includes any practical combination of the structures and method steps disclosed. The words “and” and “or” as used herein shall be construed both conjunctively and disjunctively and each shall include the other (e.g., and/or) whenever practical unless expressly stated otherwise. While for the sake of clarity of description several specifics embodiments of the invention have been described, the scope of the invention is intended to be measured by the claims as set forth below.

What is claimed is:

1. A mount for coupling to a provided object, releasably coupling to a provided security device, and providing an information, the mount comprising:
a body;
a first coupler for coupling the body to the object;
a second coupler for releasably coupling the body to the security device;
a conductor for electrically coupling to the security device; and
a data carrier positioned in the body that electrically couples to the conductor to provide the information via the conductor; wherein:
the security device receives the information only while coupled to the second coupler;
the data carrier remains in the body while the security device is decoupled from second coupler; and
the information comprises a unique identifier.
